(19) United States
(12) Patent Application Publication
(10) Pub. No.: US 2026/0358771 A1
(43) Pub. Date: Nov. 12, 2026

(54) Device Control Method and Apparatus, and Storage Medium

(71) Applicant: China United Network Communications Group Company Limited, Beijing (CN)

(72) Inventors: Xin Wang, Beijing (CN); Xinzhou Cheng, Beijing (CN); Renfang Tang, Beijing (CN); Yue Wang, Beijing (CN); Bo Hu, Beijing (CN); Shuyuan Wang, Beijing (CN); Sainan Hou, Beijing (CN)

(21) Appl. No.: 19/113,716

(22) PCT Filed: Sep. 18, 2023
(86) PCT No.: PCT/CN2023/119372

§ 371 Date: Mar. 20, 2025

(30) Foreign Application Priority Data
Sep. 20, 2022 (CN) 202211142929.9

(51) Int. Cl. G05B 15/02

(52) U.S. Cl. CPC G05B 15/02

(57) ABSTRACT

A device control method, where the method includes receiving a human computer interaction message from a terminal; determining an instruction work order according to the human computer interaction message; the instruction work order is used to control an Internet of Things (IoT) device; and transmitting the instruction work order to the IoT device.

### CROSS-REFERENCE TO RELATED APPLICATIONS

This application is the United States national phase of International Patent Application No. PCT/CN2023/119372, and claims priority to Chinese Patent Application No. 202211142929.9, filed Sep. 20, 2022, the disclosures of which are hereby incorporated by reference in their entireties.

### BACKGROUND OF THE INVENTION

### Field of the Invention

The present disclosure relates to the field of communication, and in particular to a device control method, a device control apparatus, and a storage medium.

### Description of Related Art

Currently, the user cannot interact with Internet of Things devices directly in a language that can be understood by the user. For example, when the user needs to know the brightness of an Internet of Things device, he/she needs to control the Internet of Things device separately through a platform or APP. Therefore, in the context of the future Internet of Everything, the user will need to download many different Internet of Things device apps, and then learn complex functions in the app or platform to control Internet of Things devices and acquire data from them. The process is relatively complex, resulting in a poor user experience.

### SUMMARY OF THE INVENTION

The present disclosure provides a device control method, a device control apparatus, and a storage medium, which can solve the problems of complex processes and poor experience when users interact with Internet of Things devices in the current stage.

For this, the present disclosure adopts following technical solutions.

In a first aspect, the present disclosure provides a device control method, and the method includes: receiving a human computer interaction message from a terminal; determining an instruction work order according to the human computer interaction message; where the instruction work order is used to control an Internet of Things device; and transmitting the instruction work order to the Internet of Things device.

Based on the above technical solutions, in the present disclosure, after the human computer interaction message generated in response to the operations of the user from the terminal is received, the instruction work order that the Internet of Things device can recognize is received according to the human computer interaction message, the control intention of the user for the Internet of Things device is converted into machine instructions that the Internet of Things device can recognize, and the machine instructions are transmitted to the Internet of Things device, so that the Internet of Things device can perform corresponding operations based on the instruction work order, or report the target data required by the user, so as to meet the control intention of the user for the Internet of Things device. The human computer interaction message may be in the form of an RCS message. Therefore, as long as the terminal used by the user has the rich communication service (RCS) message function, the user may communicate directly with the Internet of Things device through human language without downloading various types of APPs. The process is simple and improves the user experience of the Internet of Things device of the user.

In an implementation, the human computer interaction message includes statement command information and an identity (ID) of the Internet of Things device; the statement command information is determined by the terminal in response to an interactive operation of a user.

In an implementation, determining the instruction work order according to the human computer interaction message specifically includes: determining an instruction work order according to the statement command information and the instruction graph; where the instruction graph is used to characterize a mapping relationship between the statement command information and the instruction work order.

In an implementation, before the receiving the human computer interaction message from the terminal, the method further includes: receiving request information from the terminal; and determining the ID of the Internet of Things device according to the request information of the terminal.

In an implementation, the above method further includes: determining a mapping relationship table; where the mapping relationship table is used to characterize a correspondence between an ID of an Internet of Things device and a URL link of the Internet of Things management platform; and the Internet of Things management platform is used to control an Internet of Things device.

In an implementation, the transmitting the instruction work order to the Internet of Things device specifically includes: determining the URL link of the Internet of Things management platform according to the ID of the Internet of Things device and the mapping relationship table; and transmitting the instruction work order to the Internet of Things management platform according to the URL link of the Internet of Things management platform, to enable the Internet of Things management platform to transmit the instruction work order to the Internet of Things device.

In an implementation, the above method further includes: constructing a capability graph of a plurality of Internet of Things devices; where the capability graph of a plurality of Internet of Things devices is used to characterize capability information of the plurality of Internet of Things devices and an interconnection relationship between the plurality of Internet of Things devices; constructing a user behavior graph; where the user behavior graph is used to characterize the usage behavior habit of the user for the Internet of Things devices, and the interconnection relationship between a plurality of users and between the user and Internet of Things device; determining an instruction graph according to the capability graph of the plurality of Internet of Things devices and the user behavior graph.

In an implementation, the determining the instruction graph according to the capability graph of the plurality of Internet of Things devices and the user behavior graph specifically includes: periodically adjusting the interconnection relationship between the user and the plurality of Internet of Things devices in the capability graph of the plurality of Internet of Things devices and the user behavior graph according to time information and geographic location information; categorically labelling entities in the capability graph of the plurality of Internet of Things devices and the user behavior graph according to labelled reference data to determine an instruction graph; where the labelled reference data includes one or more of: an instruction information field, a file address link, a time parameter, and a quantity parameter.

In an implementation, before the transmitting the instruction work order to the Internet of Things device, the method further includes: determining instruction work order confirmation information according to the instruction work order; transmitting the instruction work order confirmation information; where the instruction work order confirmation information is used to indicate the terminal to confirm the instruction work order; receiving instruction work order feedback information; where the instruction work order feedback information is used to characterize a confirmation result of the terminal for the instruction work order.

In an implementation, the above method further includes: receiving target data transmitted from the Internet of Things device; where the target data is data obtained as indicated by the statement command information; performing a semantic synthesis on the target data according to the statement command information to determine first statement information; and transmitting the first statement information to the terminal.

In a second aspect, the present disclosure provides a device control apparatus, and the device control apparatus includes: a receiving unit, a processing unit and a transmitting unit; where the receiving unit is configured to receive a human computer interaction message from a terminal; the processing unit is configured to determine an instruction work order according to the human computer interaction message; the instruction work order is used to control an Internet of Things device; the transmitting unit is configured to transmit an instruction work order to the Internet of Things device.

In an implementation, the human computer interaction message includes statement command information and an identity (ID) of the Internet of Things device; the statement command information is determined by the terminal in response to an interactive operation of a user.

In an implementation, the processing unit is further configured to determine an instruction work order according to the statement command information and an instruction graph; where the instruction graph is used to characterize a mapping relationship between the statement command information and the instruction work order.

In an implementation, the receiving unit is further configured to receive request information from the terminal; the processing unit is further configured to determine the ID of the Internet of Things device according to the request information of the terminal.

In an implementation, the processing unit is further configured to determine a mapping relationship table; where the mapping relationship table is used to characterize a correspondence between an ID of an Internet of Things device and a URL link of an Internet of Things management platform; the Internet of Things management platform is used to control an Internet of Things device.

In an implementation, the processing unit is further configured to determine the URL link of the Internet of Things management platform according to the ID of the Internet of Things device and the mapping relationship table; the processing unit is further configured to transmit the instruction work order to the Internet of Things management platform according to the URL link of the Internet of Things management platform, to enable the Internet of Things management platform to transmit the instruction work order to the Internet of Things device.

In an implementation, the processing unit is further configured to: construct a capability graph of a plurality of Internet of Things devices; where the capability graph of a plurality of Internet of Things devices is used to characterize capability information of the plurality of Internet of Things devices and the interconnection relationship between the plurality of Internet of Things devices; the processing unit is further configured to construct a user behavior graph; where the user behavior graph is used to characterize a usage behavior habit of a user for the Internet of Things devices, and the interconnection relationship between a plurality of users and between the user and Internet of Things device; the processing unit is further configured to determine an instruction graph according to the capability graph of the plurality of Internet of Things devices and the user behavior graph.

In an implementation, the processing unit is further configured to: periodically adjust the interconnection relationship between the user and the plurality of Internet of Things devices in the capability graph of the plurality of Internet of Things devices and the user behavior graph according to time information and geographic location information; the processing unit is further configured to categorically label entities in the capability graph of the plurality of Internet of Things devices and the user behavior graph according to labelled reference data to determine an instruction graph; where the labelled reference data includes one or more of: an instruction information field, a file address link, a time parameter, and a quantity parameter.

In an implementation, the processing unit is further configured to determine instruction work order confirmation information according to the instruction work order; the transmitting unit is further configured to transmit the instruction work order confirmation information; where the instruction work order confirmation information is used to indicate the terminal to confirm the instruction work order; the receiving unit is further configured to receive instruction work order feedback information; the instruction work order feedback information is used to characterize a confirmation result of the terminal for the instruction work order.

In an implementation, the receiving unit is further configured to: receive target data transmitted from the Internet of Things device; where the target data is data obtained as indicated by the statement command information; the processing unit is further configured to perform a semantic synthesis on the target data according to the statement command information to determine first statement information; the transmitting unit is further configured to transmit the first statement information to the terminal.

In a third aspect, the present disclosure provides a device control apparatus and the apparatus includes: a processor and a communication interface, the communication interface is coupled to the processor, and the processor is configured to execute a computer program or instructions to implement the device control method according to the first aspect and any one of implementations of the first aspect.

In a fourth aspect, the present disclosure provides a computer-readable storage medium having instructions stored therein, the instructions, when executed on a terminal, cause the terminal to perform the device control method according to the first aspect and any one of implementations of the first aspect.

In a fifth aspect, the present disclosure provides a computer program product containing instructions. The computer program product, when executed on a device control apparatus, causes the device control apparatus to perform the device control method according to the first aspect and any one of implementations of the first aspect.

In a sixth aspect, the present disclosure provides a chip, and the chip includes a processor and a communication interface, the communication interface is coupled to the processor. The processor is configured to execute a computer program or instructions to implement the device control method according to the first aspect and any one of implementations of the first aspect.

Specifically, the chip provided by the present disclosure further includes a memory configured to store a computer program or computer instructions.

It should be noted that, all or part of the above computer instructions may be stored on a computer-readable storage medium. Herein, the computer-readable storage medium may be packaged together with the processor of the apparatus, or may be packaged separately with the processor of the apparatus, which is not limited to the present disclosure.

The descriptions of the second aspect to the sixth aspect of the present disclosure, reference may be made to the detailed description of the first aspect; and the beneficial effects of the descriptions of the second aspect to the sixth aspect, reference may be made to the beneficial effect analyses of the first aspect, which will not be repeated herein.

In the present disclosure, the names of the device control apparatus, receiving unit, processing unit, and transmitting unit mentioned above do not limit the devices or functional modules themselves. In actual implementations, these devices or functional modules may appear under other names. As long as functions of the devices or functional modules are similar to those of the present disclosure, they fall within the scope of the claims and their equivalent technologies of the present disclosure.

These and other aspects of the present disclosure will become more apparent from the following description.

### BRIEF DESCRIPTION OF THE DRAWINGS

FIG. 1 is a flow schematic diagram of creating a session based on an SIP signaling, provided by the embodiments of the present disclosure.

FIG. 2 is a flow schematic diagram of modifying a session based on an SIP signaling, provided by the embodiments of the present disclosure.

FIG. 3 is a flow schematic diagram of ending a session based on an SIP signaling, provided by the embodiments of the present disclosure.

FIG. 4 is a schematic diagram of a NIP graph, provided by the embodiments of the present disclosure.

FIG. 5 is an architecture schematic diagram of a device control system, provided by the embodiments of the present disclosure.

FIG. 6 is a flow schematic diagram of a device control method, provided by the embodiments of the present disclosure.

FIG. 7 is a flow schematic diagram of another device control method, provided by the embodiments of the present disclosure.

FIG. 8 is a flow schematic diagram of another device control method, provided by the embodiments of the present disclosure.

FIG. 9 is a flow schematic diagram of another device control method, provided by the embodiments of the present disclosure.

FIG. 10 is a schematic diagram of a capability graph of an Internet of Things device, provided by the embodiments of the present disclosure.

FIG. 11 is a schematic diagram of a user behavior graph, provided by the embodiments of the present disclosure.

FIG. 12 is a flow schematic diagram of another device control method, provided by the embodiments of the present disclosure.

FIG. 13 is a schematic diagram of an instruction graph, provided by the embodiments of the present disclosure.

FIG. 14 is a schematic diagram of another instruction graph, provided by the embodiments of the present disclosure.

FIG. 15 is a schematic diagram of a topological structure of an instruction graph, provided by the embodiments of the present disclosure.

FIG. 16 is a flow schematic diagram of another device control method, provided by the embodiments of the present disclosure.

FIG. 17 is a flow schematic diagram of another device control method, provided by the embodiments of the present disclosure.

FIG. 18 is a structural schematic diagram of a device control apparatus, provided by the embodiment of the present disclosure.

FIG. 19 is a structural schematic diagram of another device control apparatus, provided by the embodiment of the present disclosure.

### DESCRIPTION OF THE INVENTION

The technical solutions in the embodiments of the present disclosure will be described below clearly and completely with reference to the drawings in embodiments of the present disclosure. Obviously, the described embodiments are merely some but not all of the embodiments of the present disclosure. All other embodiments obtained based on the embodiments of the present disclosure by those of ordinary skilled in the art without paying any creative effort shall be included in the protection scope of the present disclosure.

The term “and/or” in the present document is only used to describe an association relationship between associated objects, and means the existence of three relationships, for example, A and/or B may mean the existence of only A, both A and B, and only B.

The terms “first” and “second” in the specification and drawings of the present disclosure are used to distinguish different objects, or to distinguish different processing of a same object, rather than describing a specific order of objects.

Furthermore, the terms “comprising/including” and “having” and any variations thereof mentioned in the descriptions of the present disclosure are intended to cover non-exclusive inclusion. For example, a procedure, a method, a system, a product or a device that contains a series of steps or units is not limited to the listed steps or units, but optionally also includes other unlisted steps or units, or optionally also includes other steps or units inherent to such procedure, method, product or device.

It should be noted that, in the embodiments of the present disclosure, the words such as “exemplary” or “for example” are used to represent an example, illustration, or explanation. Any embodiment or design solution described in connection with “exemplary” or “for example” in the embodiments of the present disclosure is not necessarily to be construed as preferred or advantageous over other embodiments or design solutions. To be precise, the usage of the words, such as “exemplary” or “for example”, is intended to present relevant concepts in a specific manner.

In the description of the embodiments of the present disclosure, “multiple” means two or more than two, unless otherwise stated.

Terms involved in the embodiments of the present disclosure are explained to facilitate the understanding of readers below.

### I. Rich Communication Service

Rich communication service (RCS) is a synonym for the fifth-generation mobile communication technology (5G) message, also referred to as converged communication. The RCS message overcomes the text-only limitation inherent in traditional messages, and supports a plurality of formats such as files, videos, pictures, audio, etc.

The RCS message brings a new human computer interaction mode. A user may complete one-stop services such as service search, discovery, interaction, and payment within the message window.

When using the RCS message, the user does not need to download a plurality of terminal application (application, app) clients. The user may receive the RCS message through the native message entrance on the terminal. The problem of decreased user sensing caused by the current excessive number of apps will be effectively solved. The government and business may also directly deliver public service and commercial service to the terminal of the user through the RCS message.

In the present disclosure, the human computer interaction message may be in the form of an RCS message. Specifically, a terminal responds to an operation of a user and transmits command statement information input by the user to an Internet of Things management platform in the form of an RCS message, thereby implementing the user to control the Internet of Things device.

### II. IP Multimedia Subsystem Core Network

IMS is a new form of multimedia service that can meet needs of end users for newer and more diversified multimedia services. The IMS is considered to be a core technology of the next generation network and an important manner to solve integration of mobile and fixed networks and introduce differentiated services such as triple integration of voice, data and video.

The IMS core network is an important part of the IMS network architecture. IMS core network elements or modules involved in the present disclosure include: a CSCF network element and an AS network element.

Herein, the Call Session Control Function (CSCF) network element is mainly used for SIP session control based on packet switching. In the IMS, the CSCF is responsible for processing a user multimedia session and may be regarded as an SIP server in the IETF architecture. According to their different main functions, the CSCF is divided into a proxy call session control function (P-CSCF), an interrogation I-CSCF (Interrogation CSCF) and a serving CSCF (S-CSCF). The three functions may be physically separated or independent.

An application server (AS) network element is used to receive a message from a terminal and an APP on the terminal.

In addition, the present disclosure adds a first network element, a second network element, and a messaging as a platform (MaaP) in the IMS core network to implement users to control Internet of Things devices. Herein, the MaaP is equipped with a plurality of Internet of Things management platforms to implement the control of different Internet of Things devices. The specific functions of the first network element, the second network element and the MaaP platform are described below, which will not be repeated herein.

### II. Session Initiation Protocol (SIP)

An SIP session is a session between two user terminals based on an IP network, i.e., a VoIP session. The media of the session is generally voice and video, but may also be in other forms.

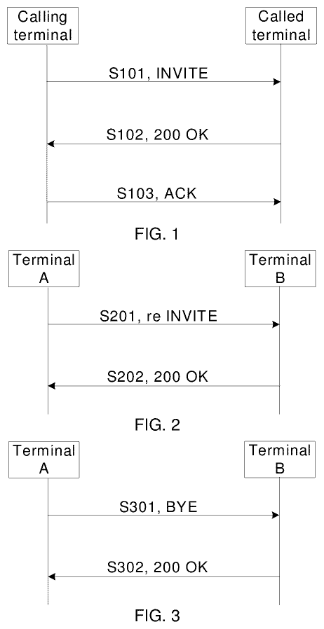

SIP itself is only responsible for establishing a session. Specifically, the SIP completes the establishment of the session by exchanging and delivering messages between two user terminals through SIP messages. The session establishment and management function of the SIP may specifically include three scenarios: creating a session, modifying a session, and ending a session. The following is a brief explanation with reference with FIG. 1 to FIG. 3.

Exemplarily, as shown in FIG. 1, the procedure of creating an SIP session is as follows.

In S101, a calling terminal transmits an INVITE to a called terminal.

Herein, the INVITE message is used to request to establish a session, and the INVITE message contains a description of a proposed session parameter.

In S102, the called terminal returns 200 OK.

Herein, the 200 OK response message contains a description of an accepted session parameter, representing that the session establishment request is accepted.

In S103, the calling terminal transmits an ACK.

Herein, the ACK message is used to confirm an establishment of the session.

Exemplarily, as shown in FIG. 2, the procedure of modifying an SIP session is as follows.

In S201, terminal A transmits re INVITE to terminal B.

Herein, the re INVITE message is used to request to modify a session between two terminals, and the re INVITE contains a description of a proposed new session parameter.

In S202, the terminal B returns 200 OK.

Herein, the 200 OK response message contains a description of an accepted session parameter, representing that the session establishment request is accepted.

Exemplarily, as shown in FIG. 3, the procedure of creating an SIP session is as follows.

In S301, terminal A transmits BYE to terminal B.

Herein, the BYE message is used to request to end the session between two terminals.

In S302, the terminal B returns 200 OK.

Herein, the 200 OK response message represents that the session end request is accepted.

In the present disclosure, the terminal is connected to the Internet of Things management platform based on the SIP session. After receiving the instruction, the Internet of Things management platform controlling different Internet of Things devices and finally controlling the Internet of Things devices by RCS messages are implemented. Specifically, an interaction procedure between the terminal and the Internet of Things management platform refers to the following embodiments, which will not be repeated herein.

### IV. Neuro-Linguistic Programming (NLP) Knowledge Graph

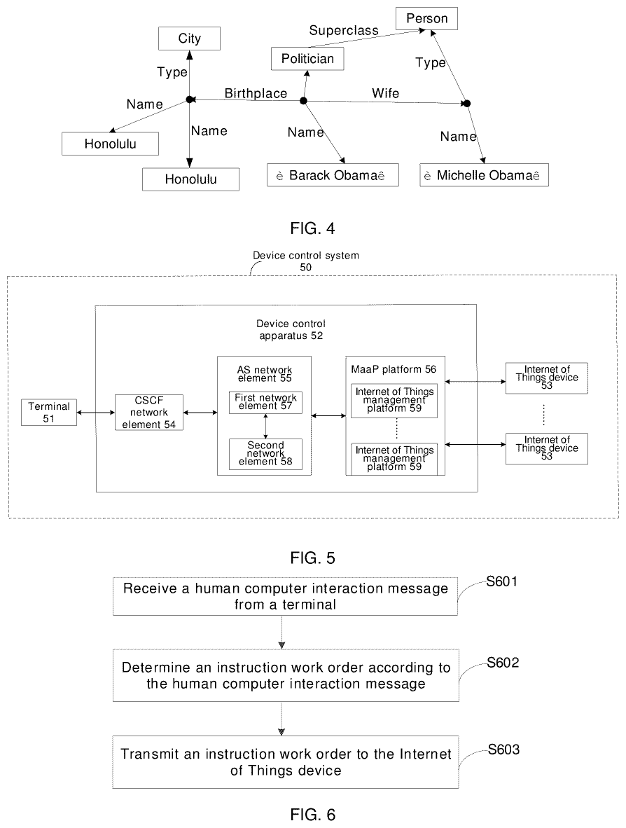

When a graph is constructed in the existing technology, the graph is mainly for analyzing the intention of the language of the user. Generally, the NLP is used to construct a knowledge graph specifically for analyzing the intention of user statement. The intention in the language of the user may be acquired by NLP knowledge graph and graph AI calculation, and the intention may be converted into user needs, and the next step is performed to control the Internet of Things device. For example, as shown in FIG. 4, the NLP graph constructs a language knowledge graph using information such as a word bag, a sentence pattern, and grammar, and performs semantic analysis from a user-understandable perspective.

### V. Instruction Work Order

The instruction work order is used to control Internet of Things devices in the Internet of Things field.

The difference between an instruction work order and statement command information is that the statement command information is information that may only be understood by users, while the instruction work order is based on statement command information and is converted by the device control apparatus so that the Internet of Things device can recognize the machine instruction. The Internet of Things device may perform corresponding operations based on the instruction work order to meet the control intentions of users for the Internet of Things device.

Some of the terms or concepts involved in the embodiments of the present disclosure are introduced below.

Currently, users cannot interact with Internet of Things devices directly in a language that users can understand. For example, when users need to know the brightness of an Internet of Things device, they need to control the Internet of Things device respectively through platform or the APPs on the terminal. Therefore, in the context of the future Internet of Everything, users will need to download many different Internet of Things device apps, and then learn the complex functions in the apps and platforms to control Internet of Things devices and acquire data from the Internet of Things devices. The process is relatively complicated, resulting in a poor user experience.

At this stage, although there are also solutions based on RCS messages, specifically through tabs in the messages to control Internet of Things devices. For example, users can select the Internet of Things devices that need to be controlled and the corresponding functions in the message. However, this still cannot implement direct interaction with Internet of Things devices in a language that users can understand, and the interaction is one-way, that is, only users can control Internet of Things devices. Numbers, parameters, complex files and other data returned by Internet of Things devices cannot be directly presented to users in a form that users can directly understand. Users still have poor experiences in the interaction with the Internet of Things devices.

In view of this, the present disclosure provides a device control method, which realizes a connection between a user terminal and an Internet of Things management platform in an SIP signaling process by deploying the Internet of Things management platform in the IMS core network. The Internet of Things management platform, after receiving the human computer interaction message transmitted from the terminal, converts statement command information included in a human computer interaction message input by the user by the terminal into an instruction work order that can be understood by an Internet of Things device based on an instruction graph and transmits the instruction work order to the Internet of Things device to implement the control of the Internet of Things device, and finally implements a new way of controlling Internet of Things devices by human computer interaction messages. The human computer interaction message may be in the form of RCS message. Therefore, as long as a mobile phone of the user has the RCS message function, there is no need to download various APPs to directly interact with Internet of Things devices in a language that can be understood by the user. The process is simple, which improves the experience of user.

The implementations of the embodiments of the present disclosure will be described in detail below in conjunction with the drawings of the specification.

Exemplarily, FIG. 5 is a network architecture diagram of a device control system 50 provided by the present disclosure. As shown in FIG. 5, the device control system 50 includes: a terminal 51, a device control apparatus 52, and an Internet of Things device 53.

Herein, the terminal 51 is connected to the device control apparatus 52 by a communication link, and the device control apparatus 52 is connected to the Internet of Things device 53 by a communication link. The communication link is a wired communication link or a wireless communication link, which is not limited to the present disclosure.

The terminal 51 is a device with a wireless communication function. The terminal 51 may be deployed on land, including indoors or outdoors, handheld or vehicle-mounted. The terminal 51 may also be deployed on water (such as ships, etc.). The terminal 51 may also be deployed in air (such as being deployed on an airplane, a balloon, and a satellite). The terminal 51 is also referred to as a user equipment (UE), a mobile station (MS), a mobile terminal (MT) or a terminal, and it is a device that provides voice and/or data connectivity to users. For example, the terminal 51 includes a handheld device, a vehicle-mounted device, etc. with a wireless connection function. At present, the terminal 51 may be: a mobile phone, a tablet computer, a laptop computer, a personal digital assistant (PDA), a mobile internet device (MID), a wearable device (such as a smart watch, a smart bracelet, a pedometer, etc.), a vehicle-mounted device (such as a car, a bicycle, an electric car, an airplane, a ship, a train, a high-speed train, etc.), a virtual reality (VR) device, an augmented reality (AR) device, a wireless terminal in industrial control, a smart home device (such as a refrigerator, a television, an air conditioner and an electric meter), an intelligent robot, a workshop device, a wireless terminal in self-driving, a wireless terminal in remote medical surgery, a wireless terminal in smart grid, a wireless terminal in transportation safety, a wireless terminal in smart city, or a wireless terminal in smart home, a flying device (such as an intelligent robot, a hot air balloon, a drone, an airplane), etc. In an application scenario of the present disclosure, the terminal device is a terminal device that generally works on the ground, such as a vehicle-mounted device. In the present disclosure, for the sake of description, a chip deployed in the above-mentioned device, such as a system-on-a-chip (SOC), a baseband chip, etc., or other chips with a communication function may also be referred to as the terminal 51.

The device control apparatus 52 is located at the IMS core network side or is a set of some specific functional network elements in the IMS core network, and may specifically include: a CSCF network element 54, an AS network element 55, and a MaaP platform 56.

Herein, the CSCF network element 54 is an existing network element in the device control apparatus, which will not be repeated in the present disclosure.

It should be noted that, the present disclosure adds a first network element 57 and a second network element 58 to the AS network element 55.

The first network element 57 is specifically used to be responsible for allocating ID numbers of various types of Internet of Things devices. Since some Internet of Things devices currently have SIM cards and some Internet of Things devices do not have SIM cards and only connect to the network via WIFI, in order to directly contact these devices by rich media messages, it is necessary to assign IDs similar to phone numbers to these devices as well.

In addition, the first network element 57, after assigning an ID number to an Internet of Things device, will establish a mapping relationship table to match a URL address of the Internet of Things management platform corresponding to the Internet of Things device with the ID of the Internet of Things device.

That is, when the RCS message is transmitted to an Internet of Things device based on the operation of the corresponding user of the terminal, it is not directly linked to the Internet of Things device, but first connected with the URL address corresponding to the Internet of Things management platform of the Internet of Things device.

In an implementation, the first network element 57 will also acquire geographic locations, network connection states, current number of service users, and IDs corresponding to the current service user of respective Internet of Things devices in real time.

Exemplarily, the mapping relationship table established by the first network element 57 is shown in Table 1 below.

TABLE 1
Mapping Relationship Table

| | Management | | | | |
|---|---|---|---|---|---|
| | platform URL | | | Current | |
| | corresponding | | Network | number of | ID corresponding |
| | to Internet of | Geographic | connection | service | to the current |
| | Things device | location | states | users | service user |
| Internet | http: . . . | Classroom | Wifi | 1 | 13566667768 |
| of Things | | center | | | |
| device | | | | | |
| ID1 | | | | | |
| Internet | http: . . . | North side | 5G | 3 | . . . |
| of Things | | of the | | | |
| device | | playground | | | |
| ID2 | | | | | |
| Internet | http: . . . | Office A | 4G | 2 | . . . |
| of Things | | | | | |
| device | | | | | |
| ID3 | | | | | |

In the Table 1, the ID corresponding to the current service user is reflected in the form of the user's mobile phone number. It should be pointed out that, the ID corresponding to the current service user may also be reflected in other forms, which is not specifically limited to the present disclosure.

In an implementation, the first network element 57, after receiving request information transmitted from the terminal, may also return one or more Internet of Things devices that meet the request information after querying the request information, as well as the IDs of these Internet of Things devices for user selection. The user may select the Internet of Things device that the user needs to interact with according to the geographic location or other significant information of the device. After the user selects an Internet of Things device, the terminal may display an ID of the Internet of Things device.

The second network element 58 is specifically used to intelligently calculate the interaction process between the user and the Internet of Things device. The network element is responsible for constructing a capability graph of a plurality of Internet of Things devices and a user behavior graph, and further constructing a deep instruction graph according to the above two graphs, and then performing artificial intelligence (AI) calculations according to constructed a plurality of graphs, and calculating instruction work orders that can be used to directly control the Internet of Things devices according to input statements, instructions or data between the user and the Internet of Things device.

It should be noted that, the specific process of the second network element 58 constructing a capability graph of a plurality of Internet of Things devices and the user behavior graph, and further constructing a deep instruction graph according to the above two graphs is shown in S901-S903 and S1201-S1202 below, which will not be repeated herein.

In an implementation, the second network element 58 is further deployed with a semantic synthesis module to convert data, parameters, and instructions fed back by the Internet of Things devices into a language that can be understood by humans.

The MaaP platform 56 is equipped with a plurality of Internet of Things management platforms 59 for receiving instruction work orders from the second network element 58 and transmitting the instruction work orders to the Internet of Things device 53.

In an implementation, the Internet of Things management platform 59 has a chatbot function. The Internet of Things management platform 59 can transmit RCS messages to the terminal used by the user based on the chatbot function. Furthermore, the Internet of Things management platform 59, after receiving the instruction work order, can determine instruction work order confirmation information according to the chatbot function and transmit the instruction work order confirmation information to the terminal, so that the user corresponding to the terminal can confirm whether the instruction work order meets own intention of the user.

In an implementation, the Internet of Things management platform 59 possesses a semantic synthesis function. Specifically, when the RCS message transmitted from the terminal 51 is to acquire target data from the Internet of Things device 53, the Internet of Things management platform 59 may receive the target data reported by the Internet of Things device 53, and perform the semantic synthesis on the target data in combination with the statement command information in the RCS message, and determine first statement information that can be understood by the user corresponding to the terminal, so that the user can acquire the target data.

In an implementation, various instructions for the Internet of Things management platform 59 to control the Internet of Things devices 53 will be stored in the instruction graph constructed by the second network element 58. For example, the instructions for the Internet of Things management platform 59 with a printing management function to control a holographic printer include: print file, the instruction is transmitted to the corresponding Internet of Things device 53 to print a file. For example, the instructions for the Internet of Things management platform 59 with a lighting control function controls a liquid crystal display (LCD) light include: turn on the light: LCD on key=1. The instruction is transmitted from the Internet of Things management platform 59 to the LCD light to turn on the LCD light, and a brightness adjustment instruction of the LCD light: LCD FLASH H+++, etc.

It should be noted that, the AS network element 55 and the MaaP platform 56 are connected in communication via a N2 interface.

The device control system provided by the present disclosure is explained above.

It will be pointed out that, in the device control method provided by the present disclosure, an execution entity is the device control apparatus. The device control apparatus may be an electronic device (such as a computer terminal, a server), may also be a processor in an electronic device, may also be a control module for device control in an electronic device, or may also be a client for device control in an electronic device.

Exemplarily, as shown in FIG. 6, the present disclosure provides a device control method, and the method specifically includes the following steps.

In S601, a device control apparatus receives a human computer interaction message from a terminal.

In some embodiments, the human computer interaction message may be in the form of an RCS message. It should be noted that, the following document and the following embodiments all take the human computer interaction message as an RCS message for example, which will not be explained below.

In an implementation, the RCS message includes statement command information and an ID of the Internet of Things device. The statement command information is specifically used to record text information or voice information etc. input via a terminal by a user.

For example, in combination with a specific scenario, when a user transmits an RCS message to an Internet of Things device by a terminal, if the ID of the Internet of Things device is already stored in a database of the terminal, the user may directly enter the ID of the Internet of Things device that needs to be interacted with at a message recipient on a display interface of the terminal. For example, ID=78006, and a message content is input according to the needs: “adjust the brightness of the holographic projection”, or “transmit a picture and text description to project the picture”, or transmit a PDF and text description to print the PDF.

In an implementation, the statement command information is determined by the terminal in response to an interactive operation of the user, and can reflect the control intention of the user for the Internet of Things device.

In an implementation, S601 may be performed by an AS network element in the device control apparatus, to enable the device control apparatus to receive the RCS message.

In S602, the device control apparatus determines an instruction work order according to the human computer interaction message.

Herein, the instruction work order is used to control the Internet of Things device. The difference between an instruction work order and statement command information is that the statement command information is information that may only be understood by users, while the instruction work order is based on statement command information and is converted by the device control apparatus so that the Internet of Things device can recognize the machine instruction. The Internet of Things device may perform corresponding operations based on the instruction work order to meet the control intentions of users for the Internet of Things device.

In an implementation, the device control apparatus determines an instruction graph, the instruction graph is used to characterize a mapping relationship between the statement command information and the instruction work order. Furthermore, the device control apparatus determines the instruction work order based on the statement command information and the instruction graph. It should be noted that, the specific process that the device control apparatus determines the instruction graph, the reference may be made to S901 to S903 and S1201 to S1202 below, which will not be repeated herein.

Exemplarily, determining the instruction work order according to the RCS message in combination with a specific signaling transmission process will be explained below. Based on an SIP session, the RCS message of the terminal will be transmitted to the IMS core network, and the signaling layer is specifically as follows: the terminal side transmitting an MSRP to the CSCF network element: request signaling, representing a request for session establishment; the CSCF network element, after receiving the request, replies to the terminal with an MSRP: 200 OK response signaling. At this time, the MSRP session is successfully established, and the statement command information in the RCS message will be transmitted to a newly added second network element in the AS network element. In conjunction with the instruction graph, the statement command information in the RCS message is calculated to analyze the intentions of the terminal user, and finally the instruction work order that can be recognized by the Internet of Things device is determined.

In an implementation, S602 may be performed by a first network element and a second network element in an AS network element in the device control apparatus, to enable the device control apparatus to determine the instruction work order according to the RCS message.

In S603, the device control apparatus transmits an instruction work order to an Internet of Things device.

It can be understood that, since the instruction work order is a machine instruction that can be recognized by the Internet of Things device, the IoT device, after receiving the instruction work order, may perform corresponding operations based on the instruction work order, or report the target data required by the user, so as to meet the control intention of the user for the Internet of Things device.

In an implementation, the device control apparatus determines a URL link of the Internet of Things management platform corresponding to the Internet of Things device according to the ID of the Internet of Things device in the RCS message, and the Internet of Things management platform as a relay, transmits the instruction work order to the Internet of Things device according to the URL link. At the same time, the Internet of Things management platform may also be used to receive target data reported by the Internet of Things device and transmit the target data to the device control apparatus.

In an implementation, S603 may be performed by an Internet of Things management platform in the device control apparatus, to enable the device control apparatus to transmit an instruction work order to the Internet of Things device.

Based on the above technical solutions, in the embodiments of the present disclosure, after the human computer interaction message generated in response to the operations of the user from the terminal is received, the instruction work order that the Internet of Things device can recognize is received according to the human computer interaction message, the control intention of the user for the Internet of Things device is converted into machine instructions that the Internet of Things device can recognize, and the machine instructions are transmitted to the Internet of Things device, so that the Internet of Things device can perform corresponding operations based on the instruction work order, or report the target data required by the user, so as to meet the control intention of the user for the Internet of Things device. The human computer interaction message may be in the form of RCS message. Therefore, as long as the terminal used by the user possesses the RCS message function, the user may communicate directly with the Internet of Things device through human language without downloading various types of APPs. The process is simple and improves the use experience of the Internet of Things device of the user.

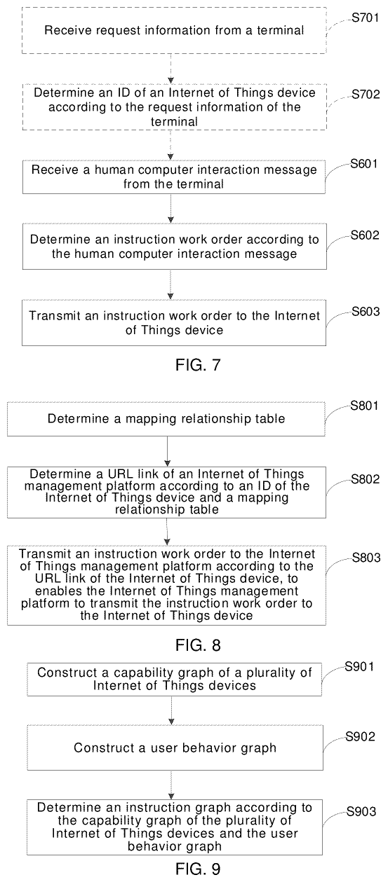

Exemplarily, in combination with FIG. 6, as shown in FIG. 7, before receiving a rich communication service (RCS) message from a terminal, the device control method provided by the present disclosure further includes the following steps.

In S701, the device control apparatus receives request information from the terminal.

Herein, the request information is used to request the ID of the Internet of Things device.

In an implementation, the request information includes keywords for reflecting features of the Internet of Things device that the user needs to control.

It can be understood that, the terminal transmits the request information to the device control apparatus, that is, the Internet of Things device that the user needs to control according to the terminal requirements this time, the ID of the Internet of Things device that is not included in the database of the terminal.

In S702, the device control apparatus determines an ID of the Internet of Things device according to the request information of the terminal.

Exemplarily, in combination with a specific scenario, the user selects a search function at a recipient contact location on a terminal display interface and inputs a keyword for the Internet of Things device, such as searching for “holographic printer”. Then the terminal transmits the request information to the device control apparatus, and the signaling format of the request information may be: <HTTP GET request: func=search: keyword=holographic printer>, and then the device control apparatus returns Internet of Things devices of one or more holographic printer that meet the keyword requirements for the user to choose after the query. The user may choose which Internet of Things device needs to interact with according to the geographical location or other significant information of the device. And after the user selects OK, a recipient address bar of the message on the display interface of the terminal is the ID of the Internet of Things device.

In an implementation, S701 to S702 may be performed by the first network element in the device control apparatus, to enable the device control apparatus, after receiving the request information from the terminal, to determine the ID of the corresponding Internet of Things device accordingly.

Based on the above technical solutions, in the embodiments of the present disclosure, the request information transmitted from the terminal is received when the ID of the Internet of Things device that the user needs to control is not included in the database of the terminal, and one or more Internet of Things devices is fed back to the terminal for the user to select the Internet of Things device that needs to be controlled, and the user is provided with the ID of the IoT device that the he/she needs to control, so as to subsequently meet the control intention of the user for the Internet of Things device.

Exemplarily, in combination with FIG. 6, as shown in FIG. 8, the device control method provided by the present disclosure further includes the following steps.

In S801, the device control apparatus determines a mapping relationship table.

Herein, the mapping relationship table is used to characterize a correspondence between the ID of the Internet of Things device and the URL link of the Internet of Things management platform.

It can be understood that, after ID numbers are allocated to the Internet of Things devices, the mapping relationship table is the mapping relationship table established by the first network element as mentioned above.

In an implementation, S801 may be performed by a first network element in the device control apparatus, to enable the device control apparatus to determine a mapping relationship table.

In S802, the device control apparatus determines a URL link of an Internet of Things management platform according to an ID of the Internet of Things device and a mapping relationship table.

Exemplarily, as shown in Table 1 above, the device control apparatus may determine the URL link of the Internet of Things management platform according to the correspondence between the ID of the Internet of Things device and its corresponding Internet of Things management platform in the mapping relationship table.

Exemplarily, the URL link of the Internet of Things management platform is determined according to the ID of the Internet of Things device and the mapping relationship table for explanation in conjunction with a specific signaling transmission process.

1) After receiving the RCS message from the terminal, the AS network element analyzes the RCS message and determines the URL link of the Internet of Things management platform.

It can be understood that, as mentioned above, Internet of Things devices may not have SIM cards and are connected to device control apparatuses by WiFi, so that the terminal cannot directly make calls or transmit messages to these Internet of Things devices. Therefore, after the first network element in the AS network element determines the mapping relationship table of the correspondence between the ID for characterizing the Internet of Things device and the URL link of the Internet of Things management platform, the AS network element may perform an analysis on the RCS message to acquire the ID of the Internet of Things device, and according to this, determine the URL link of the Internet of Things management platform corresponding to the Internet of Things device that the terminal user needs to interact with. It should be pointed out that, although the address for receiving information on the terminal display interface shows the ID of the Internet of Things device (to facilitate the terminal to record storage), the actual interaction address is the URL address of the Internet of Things management platform determined and analyzed by the AS network element.

2) The terminal activates an RCS bearer.

When activating the RCS bearer, the terminal needs to perform an SIP signaling interaction with the Internet of Things management platform corresponding to the Internet of Things device to establish a bearer. The specific process is as follows: the terminal transmitting an SIP: INVITE REQEST instruction to the CSCF network element; the CSCF network element communicating with the first network element, retrieving the URL address of the Internet of Things management platform determined by the first network element in the above steps, and establishing communication; after the communication is successfully established, the CSCF network element feeding back SIP: 100 TRYING, SIP: 180 RINGING and SIP: 200OK instructions to the terminal; the terminal transmitting an SIP: ACK instruction to the CSCF network element to confirm the establishment of the bearer.

In an implementation, S802 may be performed by the first network element in the device control apparatus, to enable the device control apparatus to determine the URL link of the Internet of Things management platform according to the ID of the Internet of Things device and the mapping relationship table.

In S803, the device control apparatus transmits an instruction work order to the Internet of Things management platform according to the URL link of the Internet of Things management platform, to enable the Internet of Things management platform to transmit the instruction work order to the Internet of Things device.

In an implementation, before the device control apparatus transmits the instruction work order to the Internet of Things management platform according to the URL link of the Internet of Things management platform, the device control apparatus first determines the instruction work order, as described in S502 above.

Exemplarily, determining by the device control apparatus, the instruction work order in conjunction with the signaling transmission process described in S802 below is explained.

It can be understood that, after the establishment of the RCS bearer is completed in S802, the SIP session is opened. At this time, the RCS message of the terminal will be transmitted to the IMS core network. The signaling layer is specifically as follows: transmitting by the terminal side MSRP to the CSCF network element: request signaling, representing a request for session establishment; after receiving the request, the CSCF network element replies to the terminal with an MSRP: 200 OK response signaling. At this time, the MSRP session is successfully established, and the statement command information in the RCS message will be transmitted to a newly added second network element in the AS network element. In conjunction with the instruction graph, the statement command information in the RCS message is calculated to analyze the intentions of the terminal user, and finally the instruction work order that can be recognized by the Internet of Things device is determined.

Furthermore, the device control apparatus, after determining the instruction work order, transmits the instruction work order to the Internet of Things management platform according to the URL link of the Internet of Things management platform, to enable the Internet of Things management platform to transmit the instruction work order to the Internet of Things device, thereby implementing the control of the Internet of Things device by the Internet of Things management platform.

In an implementation, S803 may be performed by the first network element and the second network element in the device control apparatus, so that the instruction work order is transmitted to the Internet of Things management platform according to the URL link of the Internet of Things management platform.

Based on the above technical solutions, in the embodiments of the present disclosure, the URL link of the Internet of Things management platform corresponding to the Internet of Things device is determined according to the ID of the Internet of Things device in the received human computer interaction message, and the instruction work order determined by the second network element is transmitted to the Internet of Things management platform according to the URL link, to enable the Internet of Things management platform to transmit the instruction work order to the Internet of Things device, thereby implementing the control of the Internet of Things device by the Internet of Things management platform.

Exemplarily, in combination with FIG. 6, as shown in FIG. 9, the device control method provided by the present disclosure further includes the following steps.

In S901, the device control apparatus constructs a capability graph of a plurality of Internet of Things devices.

Herein, the capability graph of the plurality of Internet of Things devices is used to characterize capability information of a plurality of Internet of Things devices and an interconnection relationship between a plurality of Internet of Things devices.

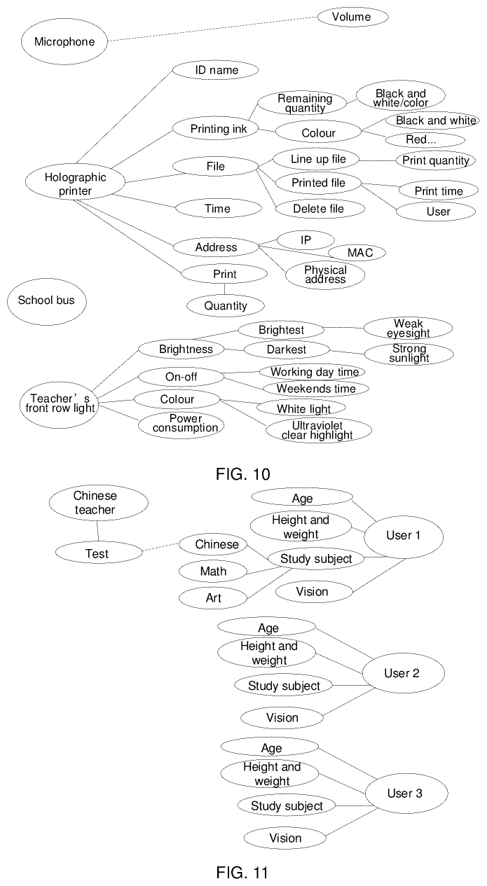

Exemplarily, as shown in FIG. 10, the capability graph of the plurality of Internet of Things devices may be a topological structure, specifically including entities of the graph and edges of the graph. The capability graph requires a basic topological structure by manual input in advance. The entities of the graph include keywords corresponding to basic capabilities of the Internet of Things device. In FIG. 9, circles are entities of the graph, and connected edges represent relationships between the entities. In this way, different graphs may be constructed according to capabilities and characteristics of different Internet of Things devices, and a plurality of Internet of Things devices may be interconnected by different relationship edges.

In an implementation, S901 may be performed by a second network element in the device control apparatus to construct a capability graph of a plurality of Internet of Things devices.

In S902, the device control apparatus constructs a user behavior graph.

Herein, the user behavior graph is used to characterize a usage behavior habit of a user for the Internet of Things device, and an interconnection relationship between a plurality of users and between the user and the Internet of Things device.

Exemplarily, as shown in FIG. 11, the user behavior graph may be a topological structure. Similar to S801, graph entities in circles in FIG. 11 represent characteristic keywords of user behavior habits, such as vision, files that may need to be printed, light preferences, spectral density of augmented reality (AR), etc. At the same time, an interconnection relationship can be formed between a plurality of users and between users and Internet of Things devices by the edges of the graph.

In an implementation, S902 may be performed by a second network element in the device control apparatus to construct a user behavior graph.

In S903, the device control apparatus determines an instruction graph according to the capability graph of a plurality of Internet of Things devices and the user behavior graph.

Herein, the instruction graph may characterize a mapping relationship between statement command information and an instruction work order.

In an implementation, the device control apparatus dynamically connects an entity edge relationship between entities in the capability graph of the plurality of Internet of Things devices and the user behavior graph, that is, adjusts the interconnection relationship between the user and the plurality of Internet of Things devices. After that, the device control apparatus categorically labels the entities in the capability graph of the plurality of Internet of Things devices and the user behavior graph based on geographic locations, network connection states, current number of service users, and IDs corresponding to the current service users of respective Internet of Things devices acquired by the first network element described above.

It should be noted that, the process of the device control apparatus specifically determining the instruction graph according to the capability graph of the plurality of Internet of Things devices and the user behavior graph, reference is made to S1201 to S1202 below, which will not be repeated herein.

In an implementation, S902 may be performed by a second network element in the device control apparatus so that an instruction graph is determined according to the capability graph of the plurality of Internet of Things devices and the user behavior graph.

Based on the above technical solutions, in the embodiments of the present disclosure, the second network element further determines the instruction graph characterizing the mapping relationship between statement command information and the instruction work order by constructing the capability graph of the plurality of Internet of Things devices and the user behavior graph to ensure normal operation of subsequent Internet of Things device control processes.

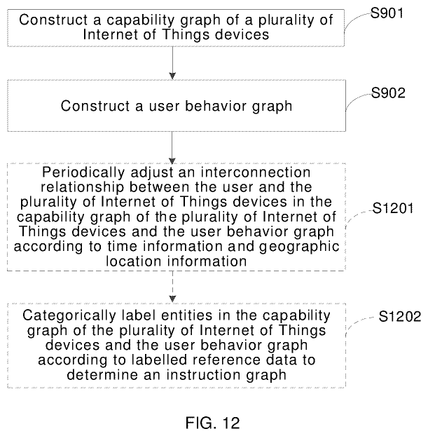

Exemplarily, in combination with FIG. 6, as shown in FIG. 12, in the device control method provided by the present disclosure, determining the instruction graph according to the capability graph of the plurality of Internet of Things devices and the user behavior graph specifically includes the following steps.

In S1201, the device control apparatus periodically adjusts an interconnection relationship between the user and the plurality of Internet of Things devices in the capability graph of the plurality of Internet of Things devices and the user behavior graph according to time information and geographic location information.

It can be understood that, the time information and geographic location information herein come from the geographic locations, network connection states, current number of service users, and IDs corresponding to the current service user of respective Internet of Things device acquired in real time by the first network element described above.

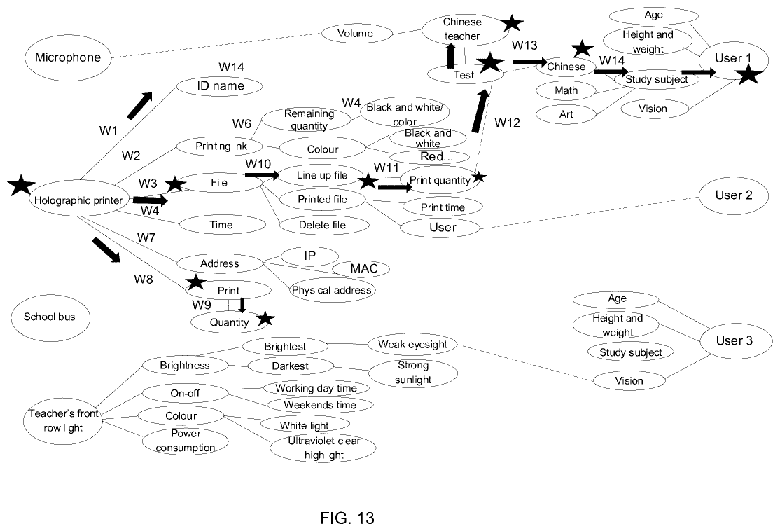

Exemplarily, FIG. 13 shows a determined instruction graph, which can reflect the adjustment made by the device control apparatus to the interconnection relationship between the user and a plurality of Internet of Things devices in the capability graph of the plurality of Internet of Things devices and the user behavior graph according to the time information and geographic location information. Specifically, the device control apparatus adjusts the interconnection relationship between the user and the plurality of Internet of Things devices in a regular and periodic manner according to time information, geographic location information, and other common sense logic. For example, when a position of user 2 in FIG. 13 moves from a playground to a classroom, the graph of user 2 and the graphs of all Internet of Things devices in the classroom will be linked by edges; similarly, after 6 o'clock in the evening, graphs of all users will be linked by edges with the graph of Internet of Things device lights; for another example, when the teaching content changes from Chinese class to math class, a weight coefficient of the link relationship between graphs of all users and the graph of the Chinese teacher changes from strong to weak, and the weight coefficient of the link relationship between graphs of all users and the graph of the math teacher changes from weak to strong.

In an implementation, S1201 may be performed by a second network element in the device control apparatus so that the interconnection relationship between the user and the plurality of Internet of Things devices in the capability graph of the plurality of Internet of Things devices and the user behavior graph is periodically adjusted according to time information and geographic location information.

In S1202, the device control apparatus categorically labels entities in the capability graph of the plurality of Internet of Things devices and the user behavior graph according to labelled reference data to determine an instruction graph.

Herein, the labelled reference data includes one or more of: an instruction information field, a file address link, a time parameter, a quantity parameter.

In an implementation, the instruction information field is obtained by the device control apparatus after performing a field extraction on the statement command information included in the RCS message, such as the instruction information field such as “file”, “photo”, “printing ink”, etc. Similarly, the time parameter and quantity parameter may also be obtained according to the statement command information.

In an implementation, when the label is performed according to the instruction information field, for the instruction information field extracted as a verb, the database corresponding to the instruction graph will record the control instruction corresponding to the corresponding Internet of Things operation platform, for example: turn on the light: LCD on key=1; copy printfile. For the instruction information fields extracted as adjectives, such as “bright” and “warm”, the database will also record the adjustment instructions corresponding to the corresponding Internet of Things operation platform. For example, the instruction corresponding to “bright” of the Internet of Things device light is: LCD FLASH H+++, and the instruction corresponding to “purple” of the holographic printing device is: Pintf COLOR=2234.

In an implementation, for the extracted time parameters and quantity parameters, the device control apparatus will acquire the quantity instruction of the rich media message of the user. For example, for holographic printing, the print number instruction related to the quantity is NUM=3, and for air conditioning, the temperature instruction related to the quantity is Tempra=24, and the time TIME=8:40 and information will be added to the corresponding position.

In an implementation, storage addresses of certain entities in the graph will be stored in the database corresponding to the instruction graph. A part of the storage addresses may be determined according to the file address link in the labelled reference data, and the other part can be manually input. For example, a certain “file” is stored in the database at the address “D:/FILE/TEMPER/USER1”; or, a certain “printing ink” is stored on the third layer of a cabinet.

Therefore, the device control apparatus categorically labels entities in the capability graph of the plurality of Internet of Things devices and the user behavior graph according to labelled reference data and combines the two graphs into a graph to determine an instruction graph.

In an implementation, S1201 may be performed by a second network element in the device control apparatus, so that entities in the capability graph of the plurality of Internet of Things devices and the user behavior graph are categorically labelled according to the labelled reference data to determine the instruction graph.

Based on the above technical solutions, in the embodiments of the present disclosure, the instruction graph that characterizes the mapping relationship between the statement command information and the instruction work order is determined by periodically adjusting the interconnection relationship in the capability graph of the plurality of Internet of Things devices and the user behavior graph and categorically labelling the entities in the two graphs according to the labelled reference data. The instruction graph of the Internet of Things device constructed in this way can further contain the instructions of the Internet of Things devices on the basis of user semantic recognition. In this way, after receiving the statement command information, the graph calculation may be directly performed according to the instruction graph for the Internet of Things device to acquire the instruction work order, which can make it easier to control the Internet of Things devices and ensure the normal operation of the subsequent Internet of Things device control process.

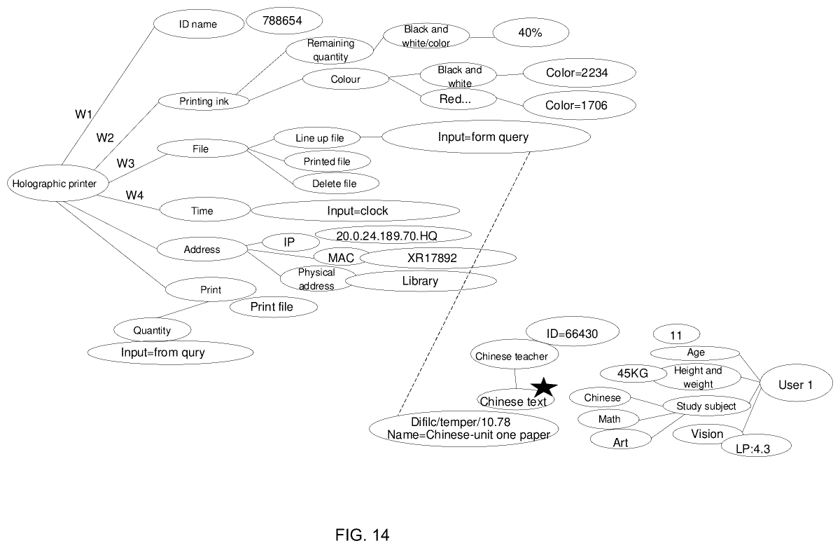

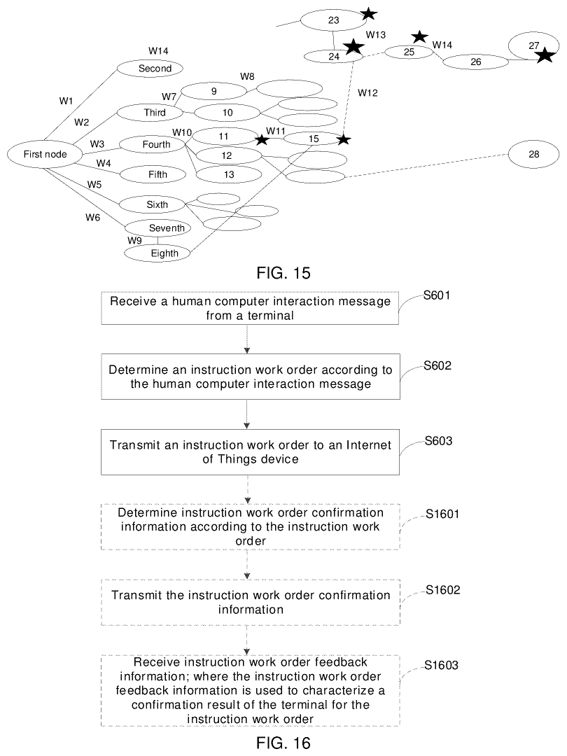

Exemplarily, in combination with FIG. 13, FIG. 14 and FIG. 15, taking the statement command information input by the user in the terminal as “Today I need to help my classmates to print ten copies of the test paper assigned by the Chinese teacher in the last class” as an example, combined with the instruction graph, the process of performing the graph calculation to acquire the instruction work order is introduced. It should be noted that, the device control apparatus in the above S602 determining the instruction work order according to the statement command information and the instruction graph, reference can be made to this distance. Here is the specific process.

In S1, the second network element analyzes the statement command information to acquire a total instruction graph.

Combined with examples, the keywords obtained and analyzed by the second network element from the sentence include: the subject entities involved “I”, “printer”, and “Chinese teacher”, the verbs being “help” and “print”, the objects being “classmates”, “the test paper of the Chinese teacher's last class”, and other keywords such as “last class, test paper, printing, quantity, subject”, etc.

Therefore, based on the keywords obtained from the above analysis, combined with the capability graph of Internet of Things devices and the user behavior graph, the total instruction graph (also known as FIG. 13) may be determined.

It can be understood that, the contents obtained by preliminary analysis are transmitted to the printer, and the printer is unable to recognize the contents. Therefore, the role of the instruction graph and graph calculation is to convert the user-understandable statements of the input by the message into instruction work orders that can be recognized by the machine.

Combined with this example, in the existing technology, NLP natural semantic recognition is performed on the sentence “I need to help my classmates”, but for Internet of Things devices, the ultimate goal is to print ten test papers, and the “information to help classmates” is actually redundant. For Internet of Things devices, the information such as “printing color”, “printer address”, “front and back printing”, and “port address” is missing. Therefore, the present disclosure can calculate and obtain the instruction work order for controlling the Internet of Things device through the instruction graph and the corresponding graph calculation, instead of analyzing redundant semantics and wasting computing resources and efficiency. The present disclosure enhances entities and edge relationships that are not covered in the human language of messages but are actually critical and necessary for controlling Internet of Things devices. Therefore, it is necessary to use the instruction graph to determine which instructions are included in the key entities that control the Internet of Things devices, and generate instruction work orders for controlling the Internet of Things devices according to these instructions, so that the user's language may be converted into instruction work orders that can be understood by the Internet of Things devices.

In S2, the second network element determines a sub-instruction graph according to the total instruction graph.

Exemplarily, combined with the examples, in the keywords obtained by the second network element from the sentence analysis, the main subjects are “I”, “printer”, and “Chinese teacher”, the verbs are “help” and “print”, and the objects are “classmates” and “the test paper of the Chinese teacher's last class”. Therefore, a topological structure with an obvious critical path may be determined in FIG. 13, and the path is marked in FIG. 13 by pentagon symbols and arrows.

Furthermore, according to the topological structure of the critical path determined in FIG. 13, a sub-instruction graph is determined, i.e., FIG. 14. It should be noted that, FIG. 14 includes the entities and edge relationships required to control the Internet of Things device.

In S3, the second network element performs a graph calculation on the sub-instruction graph to determine the instruction work order.

In an implementation, the second network element first performs a diagram neural topology on the sub-instruction graph to acquire a topology structure graph; then, determines an adjacency matrix and a degree matrix according to the topology structure graph, and finally determines the instruction work order.

Exemplarily, the process of performing the diagram neural topology according to FIG. 13 to acquire the topological structure in FIG. 15 is introduced below.

Specifically including, each entity (i.e., the ellipse in the figure) is used as a node in the diagram neural topology, and the linked relationships are used as edges. The importance of the relationship between respective entities is proposed as the W parameter, which becomes the coefficient of the edge connecting the entity points. The confirmation method of the W parameter is: 0<Wn<1, determined by keywords in the message text. If the message text includes the keywords of the entity, then the relationship between these entities, that is, the larger the W parameter of the edge, the smaller it will be. For example, in this example, the statement command information is “Today I need to help my classmates print ten copies of the test paper assigned by the Chinese teacher in the last class”, then the keywords correspond to user, classmate, Chinese teacher, last class, test paper, printing, quantity, and subject, then the W parameter between these entities is set to 0.9, and the edge relationship W of other entities of the holographic printer such as ink, address, cancel printing task, and printed file is set to 0.001. This results in a topological structure with a clear critical path, which is indicated in FIG. 13 by pentagon symbols and arrows. At the same time, the extracted topological structure graph is shown in FIG. 15, which includes 28 nodes and a plurality of edges.

In FIG. 15, the adjacency matrix A1 and degree matrix D1 of the topological structure graph can be obtained respectively according to the graph topological structure. In the degree matrix D1, all non-diagonal numbers are 0, and diagonal positions are the sum of the W parameter weights that have an edge relationship with the point; in the adjacency matrix A1, all diagonal numbers are 0, and the non-diagonal positions are the values of the W parameter weights corresponding to the nodes adjacent to the points. For example, there are 28 nodes in the topology below, a first blue node No. 1 is connected to 6 other nodes. Then 2nd, 3rd, 4th, 5th, 6th, and 7th columns of the first row of the A1 matrix are the values of W1, W2, W3, W4, W5, and W6 (4, 5, 2.3, 0.8, 0.9, and 3.1) respectively, and the rest of the positions in the row are all 0; node No. 23 represents a Chinese teacher, which is connected to another node No. 24. Then the 24th column of the 23rd row of the A1 matrix is W24, and the rest of the positions are all 0; node No. 1 represents a holographic printer, which is connected to 6 nodes. Then the first row and first column of the diagonal of the D1 matrix is the sum of W1 to W6, and the rest of the positions are all 0; node No. 4 is connected to the other 4 nodes, so the 4th row and 4th column of the diagonal of the D1 matrix is the sum of W of the edges connected to node No. 4.

The first 11 rows and 14 columns of the A1 matrix generated finally are shown in Table 2 below.

TABLE 2
Part Examples of A1 Matrix

| | | | | | | | | | | | | | | |
|---|---|---|---|---|---|---|---|---|---|---|---|---|---|---|
| 0 | 4 | 5 | 2.3 | 0.8 | 0.9 | 3.1 | 0 | 0 | 0 | 0 | 0 | 0 | 0 | . . . |
| 4 | 0 | 0 | 0 | 0 | 0 | 0 | 0 | 0 | 0 | 0 | 0 | 0 | 0 | . . . |
| 1.5 | 0 | 0 | 0 | 0 | 0 | 0 | 0 | 2.8 | 3.4 | 0 | 0 | 0 | 0 | . . . |
| | 0 | 0 | 0 | 0 | 0 | 0 | 0 | 0 | 0 | 3.6 | 7 | 4.9 | 0 | . . . |
| 6 | 0 | 0 | 0 | 0 | 0 | 0 | 0 | 0 | 0 | 0 | 0 | 0 | 0 | . . . |
| 7.2 | 0 | 0 | 0 | 0 | 0 | 0 | 0 | 0 | 0 | 0 | 0 | 0 | 0 | . . . |
| 4 | 0 | 0 | 0 | 0 | 0 | 0 | 6.6 | 0 | 0 | 0 | 0 | 0 | 0 | . . . |
| 0 | 0 | 0 | 0 | 0 | 0 | 4.9 | 0 | 0 | 0 | 0 | 0 | 0 | 5 | . . . |
| 0 | 0 | 3.7 | 0 | 0 | 0 | 0 | 0 | 0 | 0 | 0 | 0 | 0 | 0 | . . . |
| 0 | 0 | 4.1 | 0 | 0 | 0 | 0 | 0 | 0 | 0 | 0 | 0 | 0 | 0 | . . . |
| 0 | 0 | 0 | 5.6 | 0 | 0 | 0 | 0 | 0 | 0 | 0 | 0 | 0 | 3.2 | . . . |

. . .

The first 9 rows and 9 columns of the final generated D1 matrix are shown in Table 3 below.

TABLE 3
Part Examples of D1 Matrix

| | | | | | | | | | |
|---|---|---|---|---|---|---|---|---|---|
| 7 | 0 | 0 | 0 | 0 | 0 | 0 | 0 | 0 | . . . |
| 0 | 1 | 0 | 0 | 0 | 0 | 0 | 0 | 0 | . . . |
| 0 | 0 | 3 | 0 | 0 | 0 | 0 | 0 | 0 | . . . |
| 0 | 0 | 0 | 4 | 0 | 0 | 0 | 0 | 0 | . . . |
| 0 | 0 | 0 | 0 | 1 | 0 | 0 | 0 | 0 | . . . |
| 0 | 0 | 0 | 0 | 0 | 3 | 0 | 0 | 0 | . . . |
| 0 | 0 | 0 | 0 | 0 | 0 | 2 | 0 | 0 | . . . |
| 0 | 0 | 0 | 0 | 0 | 0 | 0 | 1 | 0 | . . . |
| 0 | 0 | 0 | 0 | 0 | 0 | 0 | 0 | 2 | . . . |

. . .

Exemplarily, similar to the above process of acquiring the topological structure diagram, the sub-instruction graph (i.e., FIG. 14) is performed to a diagram neural topology. Each entity is used as a point in the diagram neural topology, and the linked relationship is used as an edge to construct a topological representation of the instruction graph. The edge relationship coefficient between respective entities is defined as an M parameter. Similar to the above steps, the adjacency matrix A2 and degree matrix D2 of the instruction graph are constructed, where all numbers of non-diagonal of the degree matrix D2 are 0, and diagonal positions are the sum of the M parameter weights that have the adjacent edge relationships with the point; all numbers of the diagonal of the adjacency matrix A2 are 0, and non-diagonal positions are the M parameters of the edge relationship values between the neighboring nodes adjacent to the point.

It should be noted that, since the M parameter of the sub-instruction graph corresponding to FIG. 14 is completely different from the W parameter of the total instruction graph corresponding to FIG. 13, it is necessary to train the M coefficient matrix of the sub-instruction graph corresponding to FIG. 15 based on the adjacency matrix A1 and degree matrix D1 obtained from the total instruction graph corresponding to FIG. 13 to obtain an optimal edge relationship matrix M. The specific process is as follows.

It is obtained by the formula P=softMAX [H*W*(D2−A2)*(D1−A1)*M], where M is the coefficient matrix to be trained in the instruction graph in FIG. 15, and H is a matrix consisting of the node numbers in a path obtained from the keywords contained in the human language in the message (for example, the entities shown by the pentagon and arrows in FIG. 13, then the H matrix should include [1, 4, 7, 23, 24, 25 . . . ]). The calculation result of P is a probability value. Through iterative and repeated calculation, the initialized M parameters (for example, all M parameters are 0.5) are substituted into the above formula and the M parameters are repeatedly adjusted. When the loss function of P is minimized and the M parameters obtained are the final values. The loss function of P is to calculate the difference between the labelled category of the predicted P and the actual P. For example, when the message statement is “Today I need to help my classmates print ten copies of the test paper assigned by the Chinese teacher in the last class” as input, this information is already included in WD1\A1. Through the above formula, the probability of 28 nodes of the total instruction graph may be obtained. If the probability is greater than a threshold value 1, it means that the node, that is, the entity, needs to be added to the instruction work order (for example, the probability-calculated of the entity node corresponding to the print, quantity, file, address is greater than the threshold value 1). If the probability is less than the threshold value 1, it means that the node, that is, the entity, does not need to be added to the instruction work order (for example, the probability-calculated of the entity nodes such as vision, light brightness, classmates' textbooks, homework, and printing ink remaining is less than the threshold value 1, meaning that it is irrelevant information) and does not need to be added to the work order.

Finally, all entities in the sub-instruction graph whose probability P calculated by the above formula is greater than the threshold 1 are selected to generate an instruction work order. An example of the instruction work order is as follows.
“Executed Internet of Things device entity: holographic printer ID=788654;
Execute a print command “print file”;
File address: D: file/temper/10.78 Name=Chinese Unit 1 Test Paper;
Print quantity “ten copies”;
Print color: Color=2234;
Whether 3D holographic: Null;
Print time: current;
Whether double-sided: Null;”

It can be understood that, the above instruction work order may be recognized by the holographic printer of the Internet of Things device. Therefore, the instruction graph of the Internet of Things device constructed in the present disclosure can further contain the instructions of the Internet of Things devices on the basis of user semantic recognition. In this way, after receiving the statement command information, the graph calculation may be directly performed according to the instruction graph for the Internet of Things device to acquire the instruction work order, which can make it easier to implement the control of the Internet of Things devices and meet the control intention of the Internet of Things device by the user. Therefore, as long as the terminal used by the user has the RCS message function, the user may communicate directly with the Internet of Things device through human language without downloading various types of APPs. The process is simple and improves the use experience of the Internet of Things device of the user.

Exemplarily, in combination with FIG. 6, as shown in FIG. 16, the device control method provided by the present disclosure further includes the following steps.

In S1601, the device control apparatus determines instruction work order confirmation information according to the instruction work order.

Herein, the instruction work order confirmation information is used to indicate the terminal to confirm the instruction work order.

In an implementation, the instruction work order confirmation information may also be an RCS message.

In S1602, the device control apparatus transmits the instruction work order confirmation information.

In S1603, The device control apparatus receives instruction work order feedback information; where the instruction work order feedback information is used to characterize a confirmation result of the terminal for the instruction work order.

In an implementation, the Internet of Things management platform in the device control apparatus has a chatbot, thereby implementing the function of transmitting the RCS message to the terminal.

In an implementation, after the instruction work order is determined in the aforementioned S602, the Internet of Things management platform transmits the instruction work order confirmation information to the terminal based on the chatbot. The format of the instruction work order confirmation information may be provided to the terminal for confirmation in the form of a suggestion list, thereby avoiding incorrect estimation of the intention of the user according to the graph algorithm.

Exemplarily, a specific signaling flow of S1601-S1603 is that the second network element generates a suggestion list and delivers the suggestion list to the terminal in the form of an RCS-MSRP message. The user will receive a CHATBOT reply message in that session interface where the RCS message was just transmitted. The reply information can display the instruction work order, and there will be an operation button under the instruction work order to confirm whether to agree with. The user has a user confirmation button under the work order.

It can be understood that, when the user confirms the instruction work order, that is, when the confirmation result of the instruction work order represented by the instruction work order feedback information is confirmed, the device control apparatus transmits the instruction work order to the Internet of Things device. When the user negatives the instruction work order, that is, the confirmation result of the instruction work order represented by the instruction work order feedback information is negative, the second network element in the device control apparatus will recalculate the instruction work order according to the statement command information and the instruction graph until the user confirms that the instruction work order is correct.

Based on the above technical solutions, in the embodiments of the present disclosure, the user is enabled to confirm the instruction work order before transmitting the instruction work order to the Internet of Things device, making the control of the Internet of Things device more accurate and further improving the use experience of the Internet of Things device of the user.

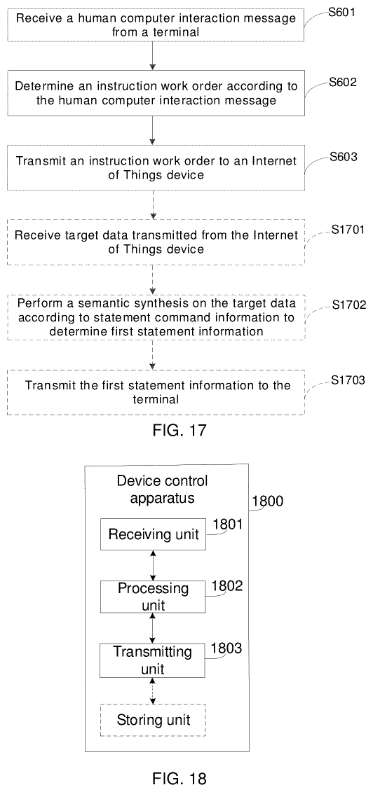

Exemplarily, in combination with FIG. 6, as shown in FIG. 17, the device control method provided by the present disclosure further includes the following steps.

In S1701, the device control apparatus receives target data transmitted from the Internet of Things device.

Herein, the target data is data acquired as indicated by the statement command information.

In S1702, the device control apparatus performs a semantic synthesis on the target data according to statement command information to determine first statement information.

It can be understood that, the situation in which the Internet of Things device reports the target data to the device control apparatus indicates that the user needs to acquire the target data by the Internet of Things device, for example, the user needs the Internet of Things device to feedback an indoor temperature or a brightness of a holographic image. At this time, the target data reported by the Internet of Things device is not necessarily in a form that can be understood by the user. Therefore, the second network element in the device control apparatus needs to perform the semantic synthesis on the target data according to the statement command information in the RCS message transmitted from the terminal in S601, and determine the first statement message so that the user can understand the message.

It should be noted that, the specific method of semantic synthesis may be found in the prior art, which is not repeated in the present disclosure.

In S1703, the device control apparatus transmits the first statement information to the terminal.

Exemplarily, a specific signaling process of S1701-S1703 is that: after the Internet of Things device feeds back required data to the Internet of Things management platform (for example: a student transmits an RCS rich media message to the cloud disk: where is the homework left by the math teacher stored on the network disk?) The cloud disk feeds back the corresponding location <ftp: 10.24.35/math/homework.2022.0327> to the Internet of Things management platform that manages the cloud disk. The Internet of Things management platform transmits the data to the second network element, and the second network element performs the semantic synthesis: <homework left by the math teacher is stored in ftp: 10.24.35/math/homework.2022.0327> of the network disk, and feeds back this content to the chatbot deployed by the Internet of Things management platform in MaaP; the chatbot then establishes an SIP signaling relationship with the terminal: SIP: INVITE REQEST signaling is transmitted from the network side to the CSCF network element, the CSCF network element then communicates with the terminal, and the MaaP in the network side feeds back SIP: 100 TRYING, SIP: 180 RINGING and SIP: 200OK signalings; the terminal transmits SIP: ACK signaling to the CSCF network again to confirm an establishment of a bearer; after the bearer is established, an MaaP session connection is established: the MaaP on the network side transmits MSRP: a request for session establishment request. The CSCF on the user terminal side, after receiving the request, will reply MSRP with a response of: 200 OK to MaaP. At this point, the MSRP session is successfully established, and the chatbot can transmit the synthesized statement to the terminal RCS-MSRP message. As a result, the user can receive a new reply message from the chatbot again on the session interface where the RCS message is transmitted displayed on the terminal.

Based on the above technical solutions, in the embodiments of the present disclosure, the semantic synthesis is performed on the target data when the Internet of Things device feeds back the target data acquired by the user, so as to determine the message that can be understood by the user, and further the user experience of the Internet of Things device of the user is improved.

The embodiments of the present disclosure may divide the functional modules or functional units of the device control apparatus according to the above method examples. For example, each functional module or functional unit may be divided to correspond to one function, or two or more functions may be integrated into a processing module. The integrated module is implemented in the form of hardware or in the form of software functional module or function unit. Herein, the division of the modules or units in the embodiments of the present disclosure is schematic, which only illustrates logical functional division, and there may be other manners to divide in actual implementation.

As shown in FIG. 18, it is a structural schematic diagram of a device control apparatus 1800, provided by the embodiments of the present disclosure. The device control apparatus 1800 includes a receiving unit 1801, a processing unit 1802, and a transmitting unit 1803.

Herein, the receiving unit 1801 is configured to receive a human computer interaction message from a terminal.

The processing unit 1802 is configured to determine an instruction work order according to the human computer interaction message; the instruction work order is used to control an Internet of Things device.

The transmitting unit 1803 is configured to transmit the instruction work order to the Internet of Things device.

In an implementation, the processing unit 1802 is further configured to determine an instruction work order according to statement command information and an instruction graph. Herein, the instruction graph is used to characterize a mapping relationship between statement command information and the instruction work order.

In an implementation, the receiving unit 1801 is further configured to receive request information from the terminal.

In an implementation, the processing unit 1802 is further configured to determine an ID of the Internet of Things device according to the request information of the terminal.

In an implementation, the processing unit 1802 is further configured to determine a mapping relationship table. Herein, the mapping relationship table is used to characterize a correspondence between the ID of the Internet of Things device and a URL link of the Internet of Things management platform. The Internet of Things management platform is used to control the Internet of Things device.

In an implementation, the processing unit 1802 is further configured to determine a URL link of the Internet of Things management platform according to the ID of the Internet of Things device and the mapping relationship table.

In an implementation, the processing unit 1802 is further configured to transmit the instruction work order to the Internet of Things management platform according to the URL link of the Internet of Things management platform, to enable the Internet of Things management platform to transmit the instruction work order to the Internet of Things device.

In an implementation, the processing unit 1802 is further configured to construct a capability graph of a plurality of Internet of Things devices. Herein, the capability graph of the plurality of Internet of Things devices is used to characterize capability information of the plurality of Internet of Things devices and an interconnection relationship between a plurality of Internet of Things devices.

In an implementation, the processing unit 1802 is further configured to construct a user behavior graph. Herein, the user behavior graph is used to characterize a usage behavior habit of a user for the Internet of Things device, and an interconnection relationship between a plurality of users and between the user and the Internet of Things device.

In an implementation, the processing unit 1802 is further configured to determine an instruction graph according to the capability graph of the plurality of Internet of Things devices and the user behavior graph.

In an implementation, the processing unit 1802 is further configured to periodically adjust the interconnection relationship between the user and the plurality of Internet of Things devices in the capability graph of the plurality of Internet of Things devices and the user behavior graph according to time information and geographic location information.

In an implementation, the processing unit 1802 is further configured to categorically label entities in the capability graph of a plurality of Internet of Things devices and the user behavior graph according to labelled reference data to determine an instruction graph. Herein, the labelled reference data includes one or more of: an instruction information field, a file address link, a time parameter, a quantity parameter.

In an implementation, the processing unit 1802 is further configured to determine instruction work order confirmation information according to the instruction work order.

In an implementation, the transmitting unit 1803 is further configured to transmit the instruction work order confirmation information. The instruction work order confirmation information is used to indicate the terminal to confirm the instruction work order.

In an implementation, the receiving unit 1801 is further configured to receive instruction work order feedback information. The instruction work order feedback information is used to characterize a confirmation result of the terminal for the instruction work order.

In an implementation, the receiving unit 1801 is further configured to receive target data transmitted from the Internet of Things device. The target data is data to be acquired as instructed by the statement command information.

In an implementation, the processing unit 1802 is further configured to perform a semantic synthesis on the target data according to the statement command information to determine first statement information.

In an implementation, the transmitting unit 1803 is further configured to transmit the first statement information to the terminal.

In an implementation, the device control apparatus 1800 may also include a storage unit (shown as a dotted box in FIG. 18), the storage unit stores a program or instructions. The processing unit 1802, when executing the program or instructions, enables the device control apparatus 1800 to perform the device control method according to the above method embodiments.

In addition, for the technical effects of the device control apparatus described in FIG. 18, reference is made to the technical effects of the device control method described in the above embodiments, which will not be repeated herein.

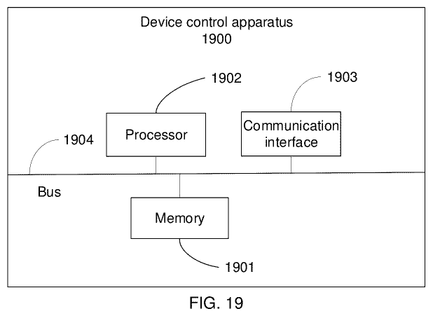

When implemented by hardware, the receiving unit 1801, the processing unit 1802 and the transmitting unit 1803 in the embodiments of the present disclosure may be integrated on a processor. The specific implementations are shown in FIG. 19.

FIG. 19 shows another structural schematic diagram of the device control apparatus involved in above embodiments. The device control apparatus 1900 includes a processor 1902 and a communication interface 1903. The processor 1902 is configured to control and manage actions of the device control apparatus, for example, to perform steps performed by the receiving unit 1801, the processing unit 1802 and the transmitting unit 1803, and/or to perform other procedures of the techniques described herein. The communication interface 1903 is used to support communication between the device control apparatus and other network entities, for example, to perform the steps performed by the receiving unit 1801, the processing unit 1802 and the transmitting unit 1803. The device control apparatus may further include a memory 1901 and a bus 1904. The memory 1901 is used for storing program codes and data of the device control apparatus.

Herein, the memory 1901 may be a memory in the device control apparatus, and the memory may include a volatile memory, such as a random access memory; the memory may also include a non-volatile memory, such as a read-only memory, a flash memory, a hard disk or solid state drive; the memory may also include a combination of the above types of memory.

The above processor 1902 may implement or execute various exemplary logical blocks, modules and circuits described in content of the present disclosure. The processor may be a central processing unit, a general-purpose processor, a digital signal processor, an application specific integrated circuit, a field programmable gate array, or other programmable logic devices, a transistor logic device, a hardware component, or any combination thereof. It may implement or execute various exemplary logical blocks, modules and circuits described in content of the present disclosure. The processor may also be a combination that implements computing functions, for example, a combination containing one or more microprocessors, a combination of a DSP and a microprocessor, or etc.

The bus 1904 may be an extended industry standard architecture (EISA) bus or the like. Buses 1904 may be divided into address buses, data buses, and control buses. For the convenience of representation, only one thick line is used in FIG. 19 for representation, but it does not mean that there is only one bus or one type of bus.

The device control apparatus in FIG. 19 may also be a chip. The chip includes one or more (including two) processor(s) 1902 and communication interface(s) 1903.

In some embodiments, the chip further includes a memory 1901, the memory 1901 may include a read-only memory and a random access memory, and provide operating instructions and data to the processor 1902. Part of the memory 1901 may include a non-volatile random access memory (NVRAM).

In some implementations, the memory 1901 stores the following elements, such as execution modules or data structures, or subsets thereof, or extended sets thereof.

In the embodiments of the present disclosure, the corresponding operations are performed by calling the operation instructions (the operation instructions may be stored in the operating system) stored in the memory 1901.

From the description of the above implementations, those skilled in the art will clearly understand that, for convenience and brevity of description, the division of the various functional modules are exemplary. In practical applications, the above-mentioned functions are allocated to different functional modules as needed. The internal structure of the apparatus is divided into different functional modules to complete all or part of the functions described above. For the specific working procedure of the above-described system, apparatus, and unit, reference may be made to the corresponding procedures in the aforementioned method embodiments, which will not repeated herein.

The embodiments of the present disclosure provide a computer program product containing instructions, the computer program product, when executed on a computer, enables the computer to perform the device control method in the above method embodiments.

The embodiments of the present embodiment further provide a computer-readable storage medium, and the computer-readable storage medium has stored instructions therein that, when executed on a computer, enable the computer to perform the device control method in the method flows shown in the above embodiments.

Herein, the computer-readable storage medium may be, for example, but is not limited to, an electronic, magnetic, optical, electromagnetic, infrared, or semiconductor system, apparatus or device, or any combination thereof. More specific examples (non-exhaustive list) of the computer-readable storage medium include: electrical connections with one or more conductors, portable computer disks, hard disks, random access memories (RAM), read only memories (ROM), erasable programmable read only memories (EPROM), registers, hard disks, optical fiber, portable compact read-only memories (CD-ROM), optical storage devices, magnetic storage devices or any suitable combination thereof, or any other form of computer readable storage medium known in the art. An exemplary storage medium is coupled to the processor such that the processor may read information therefrom, and write information thereto. Of course, the storage medium may also be an integral part of the processor. The processor and the storage medium may reside in an Application Specific Integrated Circuit (ASIC). In the embodiments of the present disclosure, the computer-readable storage medium may be any tangible medium containing or storing a program for use by or in connection with an instruction execution system, apparatus, or device.

Since the device control apparatus, computer-readable storage medium, and computer program product in the embodiments of the present disclosure may be applied to the above method, the technical effects that can be obtained can also refer to the above method embodiments, which are not limited to the embodiments of the present disclosure.

In several embodiments provided by the present disclosure, it will be understood that the disclosed system, device and method may be implemented through other manners. For example, the embodiments of the device described above are merely exemplary, for example, the division of the units is only a logical functional division. In actual implementation, there may be other division manners. For example, a plurality of units or modules are combined or integrated into another system, or some features may be ignored or not executed. Furthermore, the mutual coupling or direct coupling or communication connection shown or discussed may be an indirect coupling or communication connection through some interfaces, devices or units, and may be in an electrical, mechanical or other form.

The units described as separate components may or may not be physically separated, and the component(s) shown as units may be or may not be physical unit(s), i.e., may be located in one place, or may be distributed to a plurality of network units. Some or all of the units may be selected according to actual needs to implement the purposes of the solutions in the embodiments.

In addition, each functional unit in various embodiments of the present disclosure may be integrated into one processing unit or may be physically exist separately, or two or more units may be integrated into one unit.

The foregoing descriptions are only specific implementations of the present disclosure, but the scope of protection of the present disclosure is not limited thereto. Any changes or replacements within the technical scope disclosed in the present disclosure shall fall within the protection scope of the present disclosure. Therefore, the protection scope of the present disclosure shall be subject to the protection scope of the claims.

1. A device control method, wherein the method comprises:
receiving a human computer interaction message from a terminal;
determining an instruction work order according to the human computer interaction message; the instruction work order is used to control an Internet of Things (IoT) device; and
transmitting the instruction work order to IoT device.

2. The method according to claim 1, wherein the human computer interaction message comprises statement command information and an identity (ID) of the IoT device; the statement command information is determined by the terminal in response to an interactive operation of a user.

3. The method according to claim 2, wherein the determining the instruction work order according to the human computer interaction message comprises:
determining the instruction work order according to the statement command information and an instruction graph; wherein the instruction graph is used to characterize a mapping relationship between the statement command information and the instruction work order;
before the receiving the human computer interaction message from the terminal, the method further comprises: receiving request information from the terminal; and determining the ID of the IoT device according to the request information of the terminal.

4. (canceled)

5. The method according to claim 1, wherein the method further comprises:
determining a mapping relationship table; wherein the mapping relationship table is used to characterize a correspondence between an ID of an IoT device and a URL link of an IoT management platform; the IoT management platform is used to control an IoT device.

6. The method according to claim 5, wherein the transmitting the instruction work order to the IoT device comprises:
determining the URL link of the IoT management platform according to the ID of IoT device and the mapping relationship table; and
transmitting the instruction work order to the IoT management platform according to the URL link of the IoT management platform, to enable the IoT management platform to transmit the instruction work order to the IoT device.

7. The method according to claim 6, wherein the method further comprises:
constructing a capability graph of a plurality of IoT devices; wherein the capability graph of the plurality of IoT devices is used to characterize capability information of the plurality of IoT devices and an interconnection relationship between the plurality of IoT devices;
constructing a user behavior graph; wherein the user behavior graph is used to characterize a usage behavior habit of a user for the IoT device, and an interconnection relationship between a plurality of users and between the user and the IoT device; and
determining an instruction graph according to the capability graph of the plurality of IoT devices and the user behavior graph.

8. The method according to claim 7, wherein the determining the instruction graph according to the capability graph of the plurality of IoT devices and the user behavior graph comprises:
periodically adjusting the interconnection relationship between the user and the plurality of IoT devices in the capability graph of the plurality of IoT devices and the user behavior graph according to time information and geographic location information; and
categorically labelling entities in the capability graph of the plurality of IoT devices and the user behavior graph according to labelled reference data to determine the instruction graph; wherein the labelled reference data comprises one or more of: an instruction information field, a file address link, a time parameter, a quantity parameter.

9. The method according to claim 8, wherein before the transmitting the instruction work order to the IoT device, the method further comprises:
determining instruction work order confirmation information according to the instruction work order;
transmitting the instruction work order confirmation information; wherein the instruction work order confirmation information is used to indicate the terminal to confirm the instruction work order; and
receiving instruction work order feedback information; wherein the instruction work order feedback information is used to characterize a confirmation result of the terminal for the instruction work order.

10. The method according to claim 9, wherein the method further comprises:
receiving target data transmitted from the IoT device; wherein the target data is data acquired as indicated by statement command information;
performing a semantic synthesis on the target data according to the statement command information to determine first statement information; and
transmitting the first statement information to the terminal.

11. A device control apparatus, wherein the device control apparatus comprises: a receiving unit, a processing unit, and a transmitting unit;
the receiving unit is configured to receive a human computer interaction message from a terminal;
the processing unit is configured to determine an instruction work order according to the human computer interaction message; the instruction work order is used to control an Internet of Things (IoT) device;
the transmitting unit is configured to transmit the instruction work order to the IoT device.

12. The device control apparatus according to claim 11, wherein the human computer interaction message comprises statement command information and an identity (ID) of the IoT device; the statement command information is determined by the terminal in response to an interactive operation of a user.

13. The device control apparatus according to claim 12, wherein
the processing unit is further configured to determine the instruction work order according to the statement command information and an instruction graph; wherein the instruction graph is used to characterize a mapping relationship between the statement command information and the instruction work order;
the receiving unit is further configured to receive request information from the terminal; the processing unit is further configured to determine the ID of the IoT device according to the request information of terminal.

14. (canceled)

15. The device control apparatus according to claim 11, wherein
the processing unit is further configured to determine a mapping relationship table;
wherein the mapping relationship table is used to characterize a correspondence between an ID of an IoT device and a URL link of an IoT management platform; the IoT management platform is used to control an IoT device.

16. The device control apparatus according to claim 15, wherein
the processing unit is further configured to determine the URL link of the IoT management platform according to the ID of IoT device and the mapping relationship table;
the processing unit is further configured to transmit the instruction work order to the IoT management platform according to the URL link of the IoT management platform, to enable the IoT management platform to transmit the instruction work order to the IoT device.

17. The device control apparatus according to claim 16, wherein
the processing unit is further configured to construct a capability graph of a plurality of IoT devices; wherein the capability graph of the plurality of IoT devices is used to characterize capability information of the plurality of IoT devices and an interconnection relationship between the plurality of IoT devices;
the processing unit is further configured to construct a user behavior graph; wherein the user behavior graph is used to characterize a usage behavior habit of a user for the IoT device, and an interconnection relationship between a plurality of users and between the user and the IoT device;
the processing unit is further configured to determine an instruction graph according to the capability graph of the plurality of IoT devices and the user behavior graph.

18. The device control apparatus according to claim 17, wherein
the processing unit is further configured to periodically adjust the interconnection relationship between the user and the plurality of IoT devices in the capability graph of the plurality of IoT devices and the user behavior graph according to time information and geographic location information;
the processing unit is further configured to categorically label entities in the capability graph of the plurality of IoT devices and the user behavior graph according to labelled reference data to determine the instruction graph; wherein the labelled reference data comprises one or more of: an instruction information field, a file address link, a time parameter, a quantity parameter.

19. The device control apparatus according to claim 18, wherein
the processing unit is further configured to determine instruction work order confirmation information according to the instruction work order;
the transmitting unit is further configured to transmit the instruction work order confirmation information; wherein the instruction work order confirmation information is used to indicate the terminal to confirm the instruction work order;
the receiving unit is further configured to receive instruction work order feedback information; wherein the instruction work order feedback information is used to characterize a confirmation result of the terminal for the instruction work order.

20. The device control apparatus according to claim 19, wherein
the receiving unit is further configured to receive target data transmitted from the IoT device; wherein the target data is data acquired as indicated by statement command information;
the processing unit is further configured to perform a semantic synthesis on the target data according to the statement command information to determine first statement information;
the transmitting unit is further configured to transmit the first statement information to the terminal.

21. A device control apparatus, wherein the apparatus comprises: a processor and a communication interface, the communication interface is coupled to the processor, and the processor is configured to execute a computer program or instructions to implement steps of:
receiving a human computer interaction message from a terminal;
determining an instruction work order according to the human computer interaction message; the instruction work order is used to control an Internet of Things (IoT) device; and
transmitting the instruction work order to the IoT device.

22. A non-transitory computer-readable storage medium, wherein the computer-readable storage medium has stored instructions therein, a computer, when executing the instructions, performs the device control method according to claim 1.
